(19) United States
(12) Patent Application Publication
(10) Pub. No.: US 2006/0098441 A1
(43) Pub. Date: May 11, 2006

(54) Backlight module

(75) Inventor: Shen-Hong Chou, Kaohsiung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/079,039

(22) Filed: Mar. 14, 2005

(30) Foreign Application Priority Data
Nov. 5, 2004 (TW) 93133829

(51) Int. Cl. F21V 29/00

(52) U.S. Cl. 362/294

(57) ABSTRACT

A backlight module. A back plate comprises a first surface and a second surface. A heat-dissipating structure disposed on the second surface. A control circuit board module partially covers the first surface of the back plate. A light source module comprises a light source body, a plurality of electrodes electrically connected to the control circuit board module, and a base contacts the first surface of the back plate.

### BACKGROUND

The present invention relates to a backlight module, and more particularly relates to a backlight module of better heat-dissipating efficiency.

A liquid crystal displays (LCDs) comprises a liquid crystal panel and a backlight module. Since the liquid crystal panel does not emit light, a light source providing sufficient brightness and uniform distribution is required to properly display images. A backlight module serves as the light source for the LCDs.

Backlight modules can be categorized into directly-type and sidelight-type, in which different optical films are utilized. In sidelight-type backlight modules, the light source is disposed at a side of the light-guide plate (LGP), and guides the light toward the liquid crystal panel. In directly-type backlight modules, the light source is disposed directly in the cavity of the backlight module, and a diffuser plate uniformly diffuses the light. Further, a control circuit board module is provided to control image signals, light source, and a back plate is provided to support the backlight module.

The light source in the backlight module can be one or more lamps, such as light-emitting diodes (LEDs) or cold cathode fluorescent lamps (CCFLs). These lamps, however, generate heat in operation. Further, the control circuit board module, which generally comprises a printed circuit board (PCB), also generates heat during operation. Thus, the light source and the control circuit board module become heat sources, and the heat generated may cause overheating of the backlight module. Therefore, how to improve the heat dissipation problems of backlight module, to avoid overheating of the backlight module during operation, and damaged the backlight module. The heat dissipation in the backlight module is important.

FIG. 1 is a schematic view showing a portion of a conventional backlight module. The light source (the lamp) 110 is disposed on the circuit board 120 by connection of the electrodes 112 thereof, and the circuit board 120 is disposed on the first surface of the back plate 130. To enhance heat dissipation, a plurality of holes is provided on the circuit board 120 and the back plate 130. Further, a coating layer with high heat conducting efficiency or a heat-dissipating pad can be provided on the circuit board 120 and the back plate 130. However, heat accumulation in the conventional backlight module is still a serious problem.

### SUMMARY

Accordingly, embodiments of the present invention disclose a backlight module. The backlight module comprises a back plate, a control circuit board module, and a light source module. The back plate comprises a first surface and a second surface, with a heat-dissipating structure disposed on the second surface. The control circuit board module partially covers the first surface of the back plate. The light source module comprises a light source body, a plurality of electrodes electrically connected to the control circuit board module, and a base contacting the first surface of the back plate.

Additionally, in the backlight module mentioned above, the heat-dissipating structure comprises a plurality of heat-dissipating holes or a plurality of heat-dissipating fins parallel disposed on the second surface. As well, the light source module comprises a light-emitting diodes (LEDs).

The present invention applies directly-type or sidelight-type backlight module. A protrusion pattern or an indentation pattern is formed on the first surface to contact the base. A buffer layer is disposed between the first surface of the back plate and the control circuit board module.

A detailed description is given in the following embodiments with reference to the accompanying drawings.

### DESCRIPTION OF THE DRAWINGS

The present invention can be more fully understood by reading the subsequent detailed description and examples with references made to the accompanying drawings, wherein:

FIG. 1 is a schematic view of a conventional backlight module;

FIG. 2 is a schematic view of a backlight module of an embodiment of the invention;

FIG. 3A is a schematic view of a control circuit board module in the embodiment of the backlight module;

FIG. 3B is a plan view of the control circuit board module in the FIG. 3A;

FIG. 4A is a schematic view of another control circuit board module in the embodiment of the backlight module;

FIG. 4B is a plan view of the control circuit board module in the FIG. 4A;

FIG. 4C is a schematic view of another control circuit board module in the embodiment of the backlight module;

FIG. 5A is a schematic view of another control circuit board module in the embodiment of the backlight module;

FIG. 5B is a schematic view of another control circuit board module in the embodiment of the backlight module.

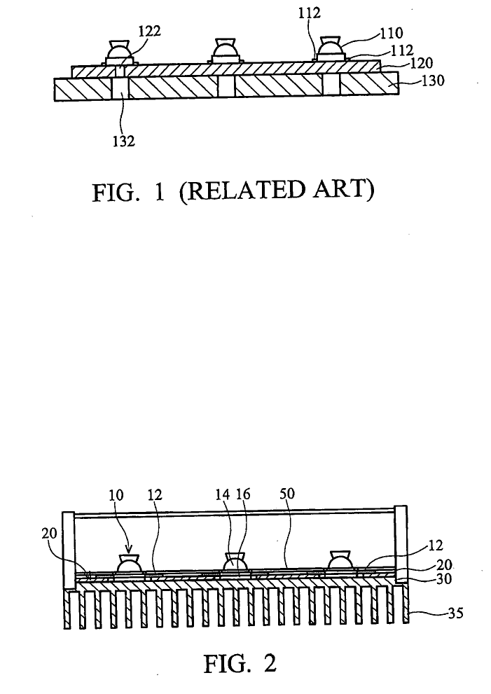

### DETAILED DESCRIPTION

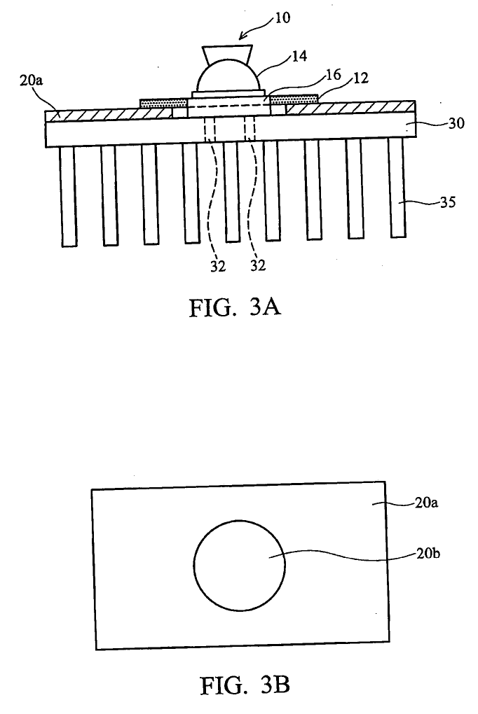

Referring to FIG. 2, a schematic view of the backlight module according to one embodiment of the present invention is shown. In FIG. 2, a backlight module comprises a light source module 10, a control circuit board module 20, and a back plate 30.

The light source module 10 can comprises light-emitting diodes (LEDs), cold cathode fluorescent lamps (CCFLs), or other lamp types. Specifically, the light source module 10 comprises two electrodes 12, a light source body 14 and a base 16. The electrodes 12 are electrically connected to the control circuit board module 20 for providing power of the light source module 10. The base 16 is a supporting member of the light source body 14. The back plate 30 has a first surface (the upper surface in FIG. 2) and a second surface (the lower surface in FIG. 2), and a heat-dissipating structure, e.g. a plurality of heat-dissipating fins 35 in FIG. 2, disposed on the second surface. The heat-dissipating fins 35 are parallel disposed on the second surface of the back plate 30 to enhance heat dissipating. The control circuit board module 20 comprises at least one circuit board, such as a printed circuit board (PCB), disposed on the first surface of the back plate 30 and partially covering the first surface of the back plate 30. Further, the light source module 10 is disposed where the first surface of the back plate 30 is not covered by the control circuit board module 20, so that the base 16 of the light source module 10 contacts the first surface of the back plate 30.

Further, the backlight module of the embodiment in FIG. 2 comprises a plurality of optical elements, such as reflective plate 50 and other optical films or plates (such as light guide plate, diffuser plate, brightness enhance film, or other element) not shown in FIG. 2. Detailed description of the optical films or plates is hereinafter omitted.

The present embodiment of the invention, the base 16 of the light source module 10 contacts the first surface of the back plate 30. Thus, heat generated by the light source module 10 is directly conducted by the back plate 30, which increases heat-dissipating efficiency of the backlight module. The heat-dissipating fins 35 on the second surface of the back plate 30 further increase the heat-dissipating efficiency.

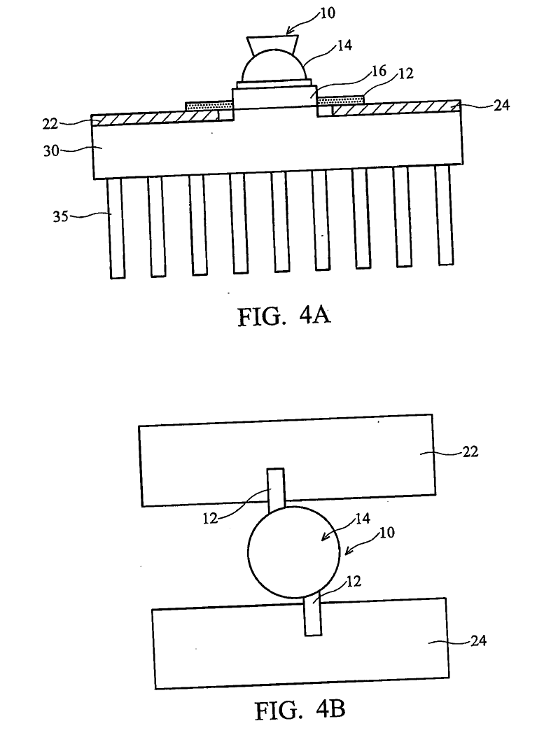

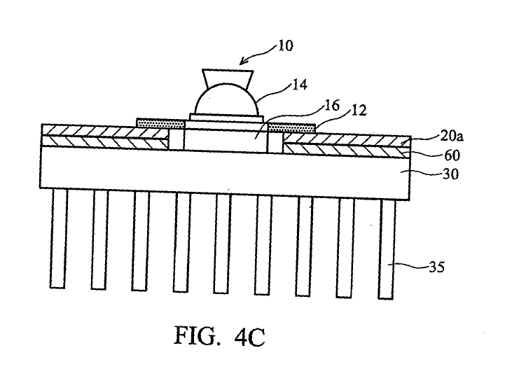

The control circuit board module 20 can comprise a single circuit board or a plurality of circuit boards. FIG. 3A and FIG. 3B show a single circuit board, and FIG. 4A and FIG. 4B show a plurality thereof.

When the control circuit board module 20 comprises a single circuit board 20a, an opening 20b is provided on the circuit board 20a. The opening 20b can be substantially circular-shaped as shown in FIG. 3B, or any other shaped corresponding to the base 16 of the light source module 10, no affect the stable of the control circuit board 20, and easily to make the opening 20b such as substantially polygon-shaped, substantially quadrilateral-shaped, substantially diamond-shaped, substantially elliptic-shaped or other-shaped. The light source module 10 is disposed on the circuit board 20a, and the base 16 contacts the first surface through the opening 20b as shown in FIG. 3A.

When the control circuit board module 20 comprises a plurality of circuit boards, such as the first circuit board 22 and the second circuit board 24 in FIG. 4A and FIG. 4B, a partially of the first surface of the back plate 30 between the first circuit board 22 and the second circuit board 24 is not covered. Thus, the electrodes 12 of the light source module 10 disposed on the first circuit board 22 and the second circuit board 24, and the electrodes 12 respectively electrically connected to the first circuit board 22 and the second circuit board 24 as shown in FIG. 4B. Further, the base 16 contacts the first surface of the back plate 30 between the first circuit board 22 and the second circuit board 24.

Electrodes 12 can be arranged with the substantially identical potential or with a potential difference therebetween. Further, the electrodes 12 can be electrically connected to both the first circuit board 22 and the second circuit board 24 or only one of the first circuit board 22 and the second circuit board 24.

While, the heat-dissipating structure in FIG. 2 comprises a plurality of heat-dissipating fins 35, or other heat-dissipating structures can be utilized in accordance with the type of backlight module and light source module 10. For example, a plurality of heat-dissipating holes 32 is disposed on the back plate 30 contacting the base 16 of the light source module 10.

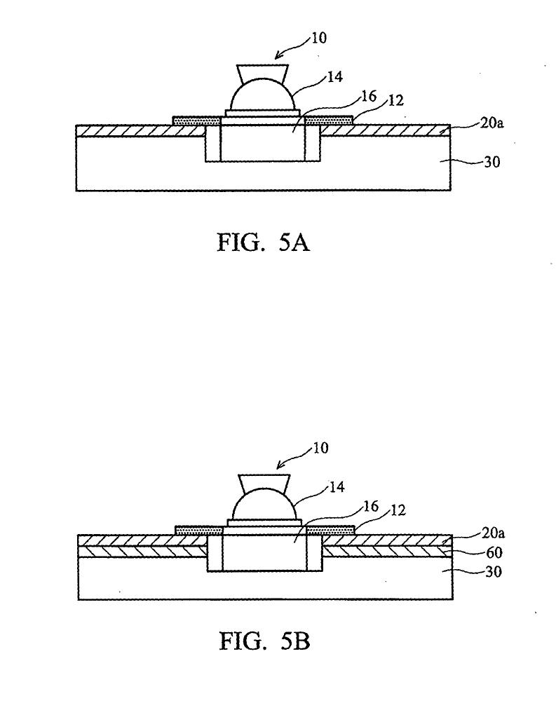

Further, for compatibility with light source modules 10 of various sizes and heights, the first surface of the back plate 30 can be formed with a protrusion pattern or an indentation pattern to contact the base 16 of the light source module 10. In FIG. 4A, for example, a protrusion pattern on the first surface of the back plate 30 between the first circuit board 22 and the second circuit board 24 allows the base 16 to fully contact the first surface. Further, in FIG. 5A, an indentation pattern on the first surface of the back plate 30 at the place corresponding to the opening of the single circuit board 20a allows the base 16 to fully contact the first surface.

To further enhance heat dissipating, it is preferable to provide a buffer layer 60 between the first surface of the back plate 30 and the control circuit board module 20. For example, the embodiment of the present invention disclosed in FIG. 4c is similar to the embodiment disclosed in FIG. 3A which constructs the control circuit board module 20 with a single circuit board 20a. The embodiment disclosed in FIG. 5B is similar to the embodiment disclosed in FIG. 5A. The difference between the embodiments is in FIGS. 4c and 5B, a buffer layer 60 disposed between the first surface of the back plate 30 and the control circuit board module 20. The material of the buffer layer 60 is corresponding to the conductivity of the base 16. When the base 16 is of conductive materials, the buffer layer 60 is of substantially insulating and high heat-conducting efficiency material (such as a refrigerating plate or a polyphenylene sulphide-based polymer). When the base 16 is of insulating materials, the buffer layer 60 is of heat-dissipating materials (such as metal or metal alloy).

The present invention improves heat dissipating by contacting the base 16 to the back plate. As well, the present invention contacts base to the back plate by forming openings on the circuit board or applying a plurality of circuit boards; thus, the design and the size of the components of the backlight module are utilized without redesign, the directly-type or sidelight-type backlight module can be utilized, the assembly and disassembly of the backlight module are facilitated, and the assembly cost of the backlight module is decreased. Additionally, light-emitting diodes (LEDs) can be utilized in the present invention to reduce manufacture cost.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A backlight module, comprising:
a back plate having a first surface and a second surface;
a heat-dissipating structure disposed on the second surface;
a control circuit board module partially covering the first surface of the back plate; and
a light source module comprising a light source body, a plurality of electrodes electrically connected to the control circuit board module, and a base contacting the first surface of the back plate.

2. The backlight module according to claim 1, wherein the control circuit board module has an opening, the light source module is disposed on the circuit board, and the base contacts the first surface through the opening.

3. The backlight module according to claim 2, wherein the opening is substantially circular-shaped, quadrilateral-shaped, or polygonal-shaped.

4. The backlight module according to claim 1, wherein the control circuit board module comprises a first circuit board and a second circuit board, the electrodes of the light source module are respectively disposed on the first circuit board and the second circuit board and respectively electrically connected to the first circuit board and the second circuit board, and the base disposed between the first circuit board and the second circuit board contacts the first surface.

5. The backlight module according to claim 1, wherein the heat-dissipating structure comprises a plurality of heat-dissipating fins disposed on the second surface.

6. The backlight module according to claim 1, wherein the heat-dissipating structure comprises a plurality of heat-dissipating holes.

7. The backlight module according to claim 1, wherein the light source module comprises one or more light-emitting diodes (LEDs).

8. The backlight module according to claim 1, wherein the first surface of the back plate has a protrusion pattern formed thereon and contacting the base.

9. The backlight module according to claim 1, wherein the first surface of the back plate has an indentation pattern formed thereon and contacting the base.

10. The backlight module according to claim 1, further comprising a buffer layer disposed between the first surface of the back plate and the control circuit board module.

11. The backlight module according to claim 10, wherein the buffer layer is comprised of a heat-dissipating material.

12. The backlight module according to claim 11, wherein the heat-dissipating material is comprised of a metal or metal alloy.

13. The backlight module according to claim 10, wherein the buffer layer is comprised of a substantially insulating and high heat-conducting efficiency material.

14. The backlight module according to claim 13, wherein the substantially insulating and high heat-conducting efficiency material is comprised of a refrigerating plate or a polyphenylene sulphide-based polymer.

15. A display apparatus having:
a panel;
an optical element, and a backlight module as claimed in claim 1.

16. The display apparatus according to claim 15, wherein the optical element comprises a diffuser plate.

17. The display apparatus according to claim 16, wherein the backlight module disposed under the panel and the diffuser plate.

18. The display apparatus according to claim 15, wherein the optical element comprises a light guide plate.

19. The display apparatus according to claim 18, wherein the backlight module disposed on the side of the light guide plate.
